(19) United States
(12) Patent Application Publication
(10) Pub. No.: US 2024/0409440 A1
(43) Pub. Date: Dec. 12, 2024

(54) WATER PURIFIER AND METHOD FOR CONTROLLING WATER PURIFIER

(71) Applicant: COWAY Co., Ltd., Gongju-si (KR)

(72) Inventor: Man KIM, Gongju-si (KR)

(73) Assignee: COWAY Co., Ltd., Gongju-si (KR)

(21) Appl. No.: 18/736,637

(22) Filed: Jun. 7, 2024

(30) Foreign Application Priority Data
Jun. 12, 2023 (KR) 10-2023-0074638

(51) Int. Cl. C02F 1/00; B01D 61/02; B01D 61/04; B01D 61/12; B67D 1/12; C02F 1/44; C02F 9/00

(52) U.S. Cl. CPC C02F 1/008; B01D 61/025; B01D 61/04; B01D 61/12; B67D 1/1243; C02F 9/00; B01D 2311/04; B01D 2313/60; B01D 2313/903; B67D 2210/0001; C02F 1/001; C02F 1/441; C02F 2201/005; C02F 2209/003; C02F 2209/02; C02F 2209/03; C02F 2209/40

(57) ABSTRACT

A water purifier is provided. The water purifier according to an aspect of the present invention includes a housing; a filter provided inside the housing to filter raw water to produce purified water; a water outlet member that ejects purified water generated in the filter to the outside of the housing; a control valve configured to control water ejection amount ejected through the water outlet member; a factor value measurement sensor configured to obtain information on water ejection amount influencing factors that may affect the water ejection amount; an input panel provided on one side of the housing to receive input of at least one of first user input information to allow to be switched to a state where a user can set the water ejection amount, second user input information on a user water ejection amount which is a water ejection amount that the user wishes to set, and user water ejection start information to ensure that water is ejected as much as the user water ejection amount; and a processor configured to control the water ejection amount using information on the water ejection amount influencing factors when the user water ejection start information is input, wherein the processor may obtain a factor value at the time of setting of the water ejection amount influencing factor when the user water ejection amount is input, obtain a factor value at the time of water ejection of the water ejection amount influencing factor when the user water ejection amount is input, and control the control valve to eject water equal to the user water ejection amount using the factor value at the time of setting, the factor value at the time of water ejection, and the second user input information.

### CROSS-REFERENCE TO RELATED APPLICATION

This application claims priority to and the benefit of Korean Patent Application No. 10-2023-0074638, filed on Jun. 12, 2023, the disclosure of which is incorporated herein by reference in its entirety.

### TECHNICAL FIELD

The present invention relates to a water purifier and a method of controlling the water purifier, and more specifically, to a water purifier capable of ejecting a predetermined amount of water and a method of controlling the water purifier.

### BACKGROUND

In general, a water purifier is an apparatus for purifying raw water supplied from a raw water source such as a tap water or bottled water bottle, and is an apparatus that supplies purified water to users by removing impurities such as heavy metals and other harmful substances contained in raw water through physical or chemical methods such as precipitation, filtration, sterilization, and the like.

Recently, water purifiers equipped with various functions to increase user convenience and control methods for water purifiers to perform these functions have been developed. As an example, there is a water purifier that has a function of ejecting a predetermined amount of water according to a user's input, and a method of controlling the water purifier to perform this function.

Korean Patent Laid-Open Publication No. 2014-0036611 of LG Electronics Co., Ltd. discloses a conventional water purifier. These conventional water purifiers are equipped with a capacity selection button that can set the amount of water supplied through the cock, allowing the user to select the water ejection amount to a specific preset value such as 0.5 liter, 1 liter, 1.5 liter, and 2 liters.

However, often, the water ejection amount desired by the user is not expressed as a measurement unit such as c, milliliter (ml), or liter (L), but is determined as a standard for the user to feel intuitively through vision or weight, such as 50% or 80% of the cup or pot used by the user.

Thus, such conventional water purifiers have a problem in that it may be difficult to select which of the water ejection amounts expressed in measurement units is appropriate in order to provide the user with the water ejection amount desired by the user. Furthermore, if the user's desired water ejection amount is different from the specific water ejection amount that can be selected by the capacity selection button, such as 1.3 liters, there is a problem in which the user cannot select and receive the desired water ejection amount.

Korean Patent Laid-Open Publication No. 2022-0047739 of LG Electronics Co., Ltd. discloses a conventional water purifier and its control method. Such a conventional water purifier and its control method are configured to obtain the time when the user presses the water outlet button multiple times as information on the water ejection amount desired by the user, and to eject water for the same amount of time as the above time in order to eject the same amount of water.

According to these conventional water purifiers and their control methods, there is a problem that it is difficult to accurately eject water in the amount set by the user. This is because the water ejection amount of the water purifier is influenced by various factors, so even if water is ejected for the same time as the pressing operation time, the final amount of water ejected may be different from the desired water ejection amount.

As an example, in a water storage type water purifier, since the water level in the water storage tank and the amount of water ejected per unit time are proportional to each other, the amount of water ejected for 10 seconds when the water level in the storage tank is lower may be different from the amount of water ejected for 10 seconds when the water level in the water tank is higher. As another example, in the case of a direct water purifier, since the pressure of the raw water flowing into the filter and the amount of water ejected per unit time are proportional, the amount of water ejected during the same time may vary depending on the pressure of the raw water.

However, in the conventional water purifier and its control method, since the time at which water is ejected is controlled so that the amount of water set by the user is ejected, due to the influence of various factors, there is a problem in accurately setting the desired water ejection amount and ejecting the corresponding amount of water.

Accordingly, there has been an urgent need for the development of a water purifier and a method for controlling the water purifier that allow the user to set the desired water ejection amount while accurately ejecting water according to the set water ejection amount.

### RELATED ART DOCUMENT

### Patent Document

(Patent Document 1) Korean Patent Laid-Open Publication No. 2014-0036611
(Patent Document 2) Korean Patent Laid-Open Publication No. 2022-0047739

### SUMMARY OF THE INVENTION

### Technical Problem

The present invention has been devised in view of the above problems, and is directed to providing a water purifier and a method for controlling the water purifier that allow the user to set the desired water ejection amount, and to eject water as much as the set amount.

The present invention is also directed to providing a water purifier and a method for controlling the water purifier that can accurately receive and process information on the water ejection amount desired by the user.

The present invention is also directed to providing a water purifier and a method for controlling the water purifier that can accurately eject water in the amount set by the user.

The present invention is also directed to providing a water purifier and a method for controlling the water purifier that can increase user convenience.

The problems of the present invention are not limited to those mentioned above, and other problems not mentioned will be clearly understood by those of ordinary skill in the art from the following description.

### Technical Solution

According to an aspect of the present invention, provided is a water purifier, including a housing; a filter provided inside the housing to filter raw water to produce purified water; a water outlet member that ejects purified water generated in the filter to the outside of the housing; a control valve configured to control water ejection amount ejected through the water outlet member; a factor value measurement sensor configured to obtain information on water ejection amount influencing factors that may affect the water ejection amount; an input panel provided on one side of the housing to receive input of at least one of first user input information to allow to be switched to a state where a user can set the water ejection amount, second user input information on a user water ejection amount which is a water ejection amount that the user wishes to set, and user water ejection start information to ensure that water is ejected as much as the user water ejection amount; and a processor configured to control the water ejection amount using information on the water ejection amount influencing factors when the user water ejection start information is input, wherein the processor obtains a factor value at the time of setting of the water ejection amount influencing factor when the user water ejection amount is input, obtains a factor value at the time of water ejection of the water ejection amount influencing factor when the user water ejection amount is input, and controls the control valve to eject water equal to the user water ejection amount using the factor value at the time of setting, the factor value at the time of water ejection, and the second user input information.

In this case, the processor may compare the factor value at the time of setting with a reference range set to reduce errors that may occur in the second user input information due to the water ejection amount influencing factor, and receive input of the second user input information if the factor value at the time of setting is within the reference range.

In this case, the processor may calculate user water ejection amount information using the second user input information, calculates a correction value to correct an error in the water ejection amount that may occur due to the difference between the factor value at the time of setting and the factor value at the time of water ejection, and calculate correction value-based water ejection amount information using the user water ejection amount information and the correction value, and control the control valve to eject water amount equal to the amount of water according to the correction value-based water ejection amount information.

In this case, a flow rate sensor for measuring actual water ejection amount ejected through the water outlet member up to a predetermined reference time point may be further included, and the processor may compare the actual water ejection amount and the user water ejection amount, maintain water ejection if the user water ejection amount is greater than the actual water ejection amount, even if the water amount equal to the amount of water according to the correction value-based water ejection amount information has been ejected, and stop water ejection if the user water ejection amount is less than or equal to the actual water ejection amount, even if the water amount equal to the amount of water according to the correction value-based water ejection amount information has not been ejected.

In this case, the input panel may be configured to receive general water ejection start information to start water ejection and general water ejection stop information to stop water ejection as the second user input information, and the processor may calculate information on the amount of water ejection time from the time water ejection starts according to the general water ejection start information to the time when water ejection is stopped according to the general water ejection stop information.

In this case, the input panel may be configured to receive input of water ejection amount selection information for selecting the amount of water to be ejected from at least one preset water ejection amount and the user water ejection amount, and general water ejection start information so as to start water ejection as much as the amount of water selected by the water ejection amount selection information, and the processor may determine that the user water ejection start information is input if the general water ejection start information is input after the water ejection amount selection information for selecting the user water ejection amount is input.

In this case, the input panel may include a water ejection amount selection button unit configured to receive input of the water ejection amount selection information by being pressed successively at least once.

In this case, the input panel may be configured to receive input of default setting information, and the processor may determine the general water ejection start information as the user water ejection start information if the default setting information is input.

In this case, the factor value measurement sensor may include at least one of a temperature sensor for measuring the temperature of water ejected through the water outlet member, a water storage sensor configured to measure the amount of water stored in a water storage tank where purified water generated by the filter is stored, and a pressure sensor for measuring the pressure of raw water flowing into the filter.

In this case, the input panel may be configured to receive input of temperature information about the temperature of the water ejected as the water ejection amount influencing factor.

According to another aspect of the present invention, provided is a method for controlling a water purifier, including obtaining information on a user water ejection amount which is a water ejection amount that a user wishes to set; receiving input of user water ejection start information to ensure that water is ejected as much as the user water ejection amount; controlling the water purifier to eject water equal to the user water ejection amount when the user water ejection start information is input, wherein the obtaining information on the user water ejection amount includes receiving input of first user input information to allow the water purifier to be switched to a state where a user can set water ejection amount; obtaining a factor value at the time of setting of a water ejection amount influencing factor that can affect the water ejection amount of the water purifier; receiving input of second user input information on a user water ejection amount which is a water ejection amount that the user wishes to set; and calculating user water ejection amount information using the second user input information, and wherein the controlling the water purifier includes obtaining a factor value at the time of water ejection of the water ejection amount influencing factor; and controlling the water ejection amount to eject water equal to the user water ejection amount using the factor value at the time of setting, the factor value at the time of water ejection, and the user water ejection amount.

In this case, the obtaining information on the user water ejection amount may include comparing the factor value at the time of setting with a reference range set to reduce errors that may occur in the second user input information due to the water ejection amount influencing factor, and the receiving input of second user input information may include receiving input of the second user input information if the factor value at the time of setting is within the reference range.

In this case, the controlling the water purifier may include calculating a correction value to correct an error in the water ejection amount that may occur due to the difference between the factor value at the time of setting and the factor value at the time of water ejection; calculating correction value-based water ejection amount information using the user water ejection amount information and the correction value; and controlling the water ejection amount of the water purifier to eject water amount equal to the amount of water according to the correction value-based water ejection amount information.

In this case, the controlling the water ejection amount of the water purifier may include measuring actual water ejection amount ejected from the start of water ejection to a predetermined reference time point; comparing the actual water ejection amount and the user water ejection amount; determining whether to stop water ejection or maintain water ejection based on the comparison result; and controlling whether to eject water from the water purifier based on the decision result.

In this case, the determining whether to stop water ejection or maintain water ejection may include determining to maintain water ejection if the user water ejection amount is greater than the actual water ejection amount, even if the water amount equal to the amount of water according to the correction value-based water ejection amount information has been ejected, and determining to stop water ejection if the user water ejection amount is less than or equal to the actual water ejection amount, even if the water amount equal to the amount of water according to the correction value-based water ejection amount information has not been ejected.

In this case, the receiving input of second user input information may include receiving general water ejection start information to start water ejection and general water ejection stop information to stop water ejection, and the calculating user water ejection amount information may include calculating information on the amount of water ejection time from the time water ejection starts according to the general water ejection start information to the time when water ejection is stopped according to the general water ejection stop information.

In this case, the receiving input of user water ejection start information may include receiving input of information for selecting the water ejection amount as the amount of water to be ejected from at least one preset water ejection amount and the user water ejection amount; and receiving general water ejection start information so as to start water ejection as much as the amount of water selected.

In this case, the receiving input of information for selecting as the amount of water to be ejected may include setting the general water ejection start information as the user water ejection start information.

In this case, the receiving input of information for selecting as the amount of water to be ejected may include successively pressing a water ejection amount selection button once or twice or more to select the amount of water to be ejected.

In this case, the water ejection amount influencing factor may include at least one of temperature of water ejected from the water purifier, amount of water storage stored in a water storage tank provided in the water purifier, and pressure of raw water flowing into the water purifier, and the correction value may include at least one of a temperature-based correction value, a water storage amount-based correction value, and a pressure-based correction value corresponding to at least one of the temperature of the water, the amount of water storage, and the pressure of raw water.

### Advantageous Effects

The water purifier and the method for controlling the water purifier according to an aspect of the present invention are configured to receive input of first and second user input information so that the user can set the desired water ejection amount, and also, they are configured to eject water ejection amount set by the user when receiving input of user water ejection start information, so that the user can receive the desired amount of water.

The water purifier and the method for controlling the water purifier according to an aspect of the present invention are configured to obtain factor value at the time of setting when receiving input of first user input information, compare the obtained factor value at the time of setting and a reference range, and receive input of second user input information according to the comparison result, so that the error in the second user input information due to the water ejection amount influencing factor can be minimized, thereby accurately receiving and processing information on the water ejection amount desired by the user, and using this information, accurately ejecting the amount of water set by the user.

The water purifier and the method for controlling the water purifier according to an aspect of the present invention are configured to obtain of factor value at the time of water ejection when receiving input of user water ejection start information, and correct the user water ejection amount information by calculating a correction value based on the factor value at the time of water ejection and the factor value at the time of setting, so that they minimize the impact according to the difference in the water ejection amount influencing factors between the time when the user sets the water ejection amount and the time when water is ejected equal to the user water ejection amount, thereby accurately ejecting the amount of water set by the user.

The water purifier and the method for controlling the water purifier according to an aspect of the present invention are configured to set general water ejection start information as user water ejection start information, so that the input of user water ejection start information can be replaced with the input of general water ejection start information, whereby the user can easily and conveniently receive water equal to the user water ejection amount.

Advantageous effects of embodiments of the present invention are not limited to the above-described effects, and other effects not mentioned will be clearly understood by those of ordinary skill in the art from the present specification and the accompanying drawings.

### BRIEF DESCRIPTION OF THE DRAWINGS

FIG. 1 is a diagram schematically illustrating a water purifier according to an exemplary embodiment of the present invention.

FIG. 2 is a plan view schematically illustrating an input panel of a water purifier according to an exemplary embodiment of the present invention.

FIG. 3 is a plan view schematically illustrating a modified example of the input panel shown in FIG. 2.

FIG. 4 is a diagram schematically illustrating a water purifier according to another exemplary embodiment of the present invention.

FIG. 5 is a flowchart of a method for controlling a water purifier according to an exemplary embodiment of the present invention.

FIG. 6 is a flowchart detailing step S100 of FIG. 5.

FIG. 7 is a flowchart detailing step S200 of FIG. 5.

FIG. 8 is a flowchart detailing step S300 of FIG. 5.

### DETAILED DESCRIPTION OF THE EMBODIMENTS

Terms and words used in the present specification and claims should not be construed as limited to their usual or dictionary definition, and they should be interpreted as a meaning and concept consistent with the technical idea of the present invention based on the principle that inventors may appropriately define the terms and concept in order to describe their own invention in the best way.

It should be understood that the terms “comprise” or “have” or the like when used in this specification, are intended to describe the presence of stated features, integers, steps, operations, elements, components and/or a combination thereof but not preclude the possibility of the presence or addition of one or more other features, integers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Some embodiments of the present disclosure may be represented by functional block configurations and various processing steps. Some or all of these functional blocks may be implemented in various numbers of hardware and/or software configurations that perform specific functions. For example, the functional blocks of the present disclosure may be implemented by one or more microprocessors or may be implemented by circuit configurations for certain functions. In addition, for example, the functional blocks of the present disclosure may be implemented in various programming or scripting languages. Functional blocks may be implemented as algorithms running on one or more processors. In addition, the present disclosure may employ conventional technologies for electronic environment setup, signal processing, and/or data processing. Terms such as “mechanism,” “element,” “means,” and “configuration” may be used broadly and are not limited to mechanical and physical components.

In this specification, a water ejection amount influencing factor refers to a factor that can affect the amount of water ejected from the water purifier. As an example, the water ejection amount influencing factor may be the amount of water stored in a water storage tank of a water storage type water purifier. This is because, in a water storage type water purifier, the pressure of the water stored in the water storage tank may affect the water ejection amount per unit time of the water storage type water purifier. As another example, the water ejection amount influencing factor may be the pressure of raw water flowing into a filter of a direct water purifier. This is because the pressure of raw water flowing into the filter in a direct water purifier can affect the water ejection amount per unit time. As yet another example, the water ejection amount influencing factor may be information about the set temperature input by the user to set the temperature of the water ejected and/or the temperature of the water ejected. This is because the amount of purified water ejected per unit time, the amount of cold water ejected per unit time, and the amount of hot water ejected per unit time may differ by the difference between the flow path from which purified water is ejected, the flow path from which cold water is ejected, and the flow path from which hot water is ejected.

The water purifier and the method for controlling a water purifier according to an embodiment of the present invention are a water purifier and a method for controlling a water purifier that can input information about the water ejection amount desired by the user (hereinafter referred to as the user water ejection amount) into the water purifier and use the information to eject water equal to the user water ejection amount.

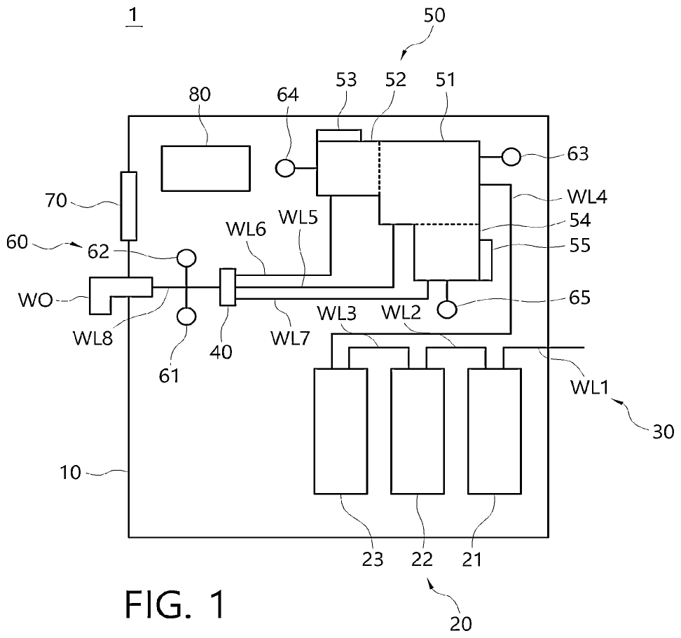

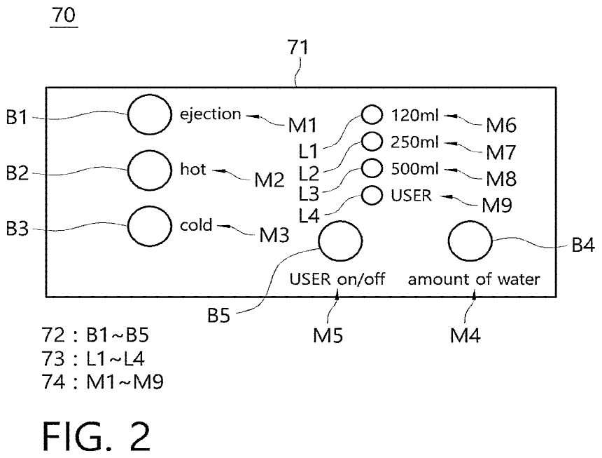

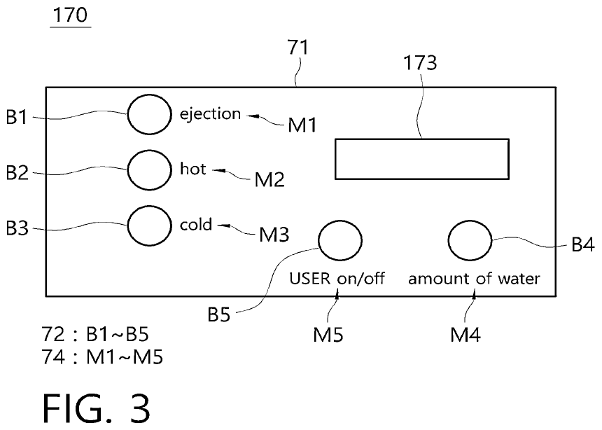

Hereinafter, a water purifier according to an embodiment of the present invention will be described. FIG. 1 is a diagram schematically illustrating a water purifier according to an exemplary embodiment of the present invention. FIG. 2 is a plan view schematically illustrating an input panel of a water purifier according to an exemplary embodiment of the present invention. FIG. 3 is a plan view schematically illustrating a modified example of the input panel shown in FIG. 2.

Referring to FIG. 1, the water purifier 1 according to an embodiment of the present invention may include a housing 10, a filter 20, an internal flow path 30, a control valve 40, a water storage tank 50, a factor value sensor 60, an input panel 70, and a processor 80. The water purifier 1 according to the present embodiment may be configured as a water storage type water purifier.

First, in the present embodiment, the housing 10 of the water purifier 1 may be configured to accommodate and protect other components of the water purifier 1, or to provide a base for installing or supporting other components.

To this end, the housing 10 may be provided as a box-shaped structure made of plastic or metal with a certain rigidity. Of course, the housing 10 may have a smooth curved outer surface as needed or may be configured to have a portion open or closed to the outside.

Next, according to the present embodiment, the filter 20 may be placed inside the housing 10. The filter 20 may be fluidly connected to the internal flow path 30, which will be described later. This filter 20 may generate purified water by receiving raw water supplied through the internal flow path 30 and filtering the supplied raw water. And, the filter 20 may eject the generated purified water back into the internal flow path 30.

In this case, at least one filter 20 may be provided. When a plurality of filters 20 are provided, the plurality of filters 20 may be fluidly connected to each other in series or parallel. Each filter 20 may be configured to perform the same function or different functions.

In the present embodiment, a plurality of filters 20 are provided. As shown, the filter 20 according to the present embodiment includes first to third filters 21 to 23 that perform different functions and are connected to each other in series.

As an example, the second filter 22 may be a reverse osmosis filter for filtering raw water, the first filter 21 located in front of the second filter 22 may be a pre-treatment filter that filters and pre-treats raw water before the reverse osmosis filter, and the third filter 23 located in rear of the second filter 22 may be a post-treatment filter that post-processes the purified water filtered by the reverse osmosis filter, but they are not limited thereto.

Next, referring back to FIG. 1, the water purifier 1 according to an embodiment of the present invention may include a water storage tank 50. As such, the water purifier 1 according to the present embodiment may be configured as a water storage type water purifier.

In this case, in the present embodiment, the water storage tank 50 may include a purified water tank 51, a hot water tank 52, a hot water unit 53, a cold water tank 54, and a cold water unit 55. The purified water tank 51, hot water tank 52, and cold water tank 54 may each be configured as a water tank in which a certain amount of water can be stored.

In the present embodiment, the purified water tank 51 may be a tank into which purified water generated by the filter 20 is introduced and stored. To this end, the purified water tank 51 may be fluidly connected to the filter 20 through the internal flow path 30, which will be described later.

And, in the present embodiment, the hot water tank 52 and the cold water tank 54 may be connected to one side and the other side of the purified water tank 51, respectively. In this case, a predetermined diaphragm may be provided between the purified water tank 51 and the hot water tank 52 and between the purified water tank 51 and the cold water tank 54, so that water in both tanks can move to each other.

Accordingly, the water in the purified water tank 51 can be moved to the hot water tank 52 or the cold water tank 54. Of course, it is not limited to this, and both tanks may be configured to be connected by the internal flow path 30.

The hot water tank 52 may be configured to store hot water having a higher temperature than the purified water in the purified water tank 51. And, the cold water tank 54 may be configured to store cold water having a lower temperature than the purified water in the purified water tank 51. Such hot and cold water can be ejected to the outside through the internal flow path 30 according to the user's input.

In the present embodiment, the hot water tank 52 and the cold water tank 54 may be equipped with a predetermined temperature control unit to maintain the temperatures of the hot water and cold water. More specifically, the hot water unit 53 may be provided on one side of the hot water tank 52, and the cold water unit 55 may be provided on one side of the cold water tank 54.

This hot water unit 53 may include a heating wire capable of emitting heat, and the heating wire may be configured to pass through the inside of the hot water tank 52 or to surround at least a portion of the outer surface of the hot water tank 52. The cold water unit 55 may include an evaporation tube capable of absorbing heat, and the evaporation tube may be configured to pass through the inside of the cold water tank 54 or to surround at least a portion of the outer surface of the cold water tank 54. The hot water unit 53 and the cold water unit 55 may be appropriately modified to suit the internal configuration of the water purifier 1.

Referring back to FIG. 1, the housing 10 of the water purifier 1 according to the present embodiment may be provided with an internal flow path 30 for fluidly connecting the above-mentioned filter 20 and water storage tank 50, etc., receiving raw water from the outside, and ejecting purified water to the outside. This internal flow path 30 may be made of a pipe made of metal, plastic, or rubber, etc., but is not limited thereto.

In the present embodiment, the internal flow path 30 may include first to eighth flow paths WL1 to WL8 and a water outlet member WO. First, the first flow path WL1 may be a flow path through which raw water flows. To this end, one side of the first flow path WL1 may be exposed or extended to the outside of the housing 10. And, the other side of the first flow path WL1 may be fluidly connected to the first filter 21. Accordingly, raw water may flow into the first filter 21.

Next, the second flow path WL2 may be configured to fluidly connect the first filter 21 and the second filter 22, and the third flow path WL3 may be configured to fluidly connect the second filter 22 and the third filter 23. As such, the second and third flow paths WL2 and WL3 may sequentially filter raw water by connecting the filters 20 in series. Of course, the connection method between the filters 20 by the internal flow path 30 may be modified as needed.

In the present embodiment, the fourth flow path WL4 may be configured to fluidly connect the third filter 23 and the purified water tank 51. Accordingly, purified water generated in the filter 20 may be introduced into the purified water tank 51 and be stored.

Meanwhile, according to the present embodiment, the fifth flow path WL5 may be fluidly connected to the purified water tank 51. This fifth flow path WL5 may be configured to fluidly connect the purified water tank 51 and the control valve 40, which will be described later. Accordingly, purified water in the purified water tank 51 may be introduced into the control valve 40.

Similarly, the sixth flow path WL6 may be fluidly connected to the hot water tank 52 to fluidly connect the hot water tank 52 and the control valve 40. And, the seventh flow path WL7 may be fluidly connected to the cold water tank 54 to fluidly connect the cold water tank 54 and the control valve 40. Accordingly, hot water in the hot water tank 52 and cold water in the cold water tank 54 may be introduced into the control valve 40.

Referring back to FIG. 1, the water outlet member WO may be installed on the outside of the housing 10. The water outlet member WO is configured to eject purified water to the outside. For example, the water outlet member WO may be provided as a faucet-shaped cock, but is not limited thereto.

In this case, in the present embodiment, the eighth flow path WL8 may be configured to fluidly connect the water outlet member WO and the control valve 40. Accordingly, the water introduced into the control valve 40 can be ejected to the outside of the water purifier 1 through the water outlet member WO via the eighth flow path WL8.

Meanwhile, according to the present embodiment, the control valve 40 may be provided in the internal flow path 30 as described above. The control valve 40 may be configured to control the flow path or flow rate of water flowing through the internal flow path 30. As an example, the control valve 40 may be configured as a solenoid valve that can be controlled electrically, but is not limited thereto.

In the present embodiment, the control valve 40 may be fluidly connected to the fifth to eighth flow paths WL5 to WL8 to connect the flow paths in a predetermined manner. For example, the control valve 40 may connect the fifth flow path WL5 and the eighth flow path WL8 to connect the flow paths so that purified water from the purified water tank 51 is ejected through the water outlet member WO, connect the sixth flow path WL6 and the eighth flow path WL8 to connect the flow paths so that hot water from the hot water tank 52 is ejected through the water outlet member WO, or connect the seventh flow path WL7 and the eighth flow path WL8 to connect the flow paths so that cold water from the cold water tank 54 is ejected through the water outlet member WO.

In this case, in the present embodiment, one valve is configured to perform the above function. However, the control valve 40 may include a plurality of valves as needed, and the plurality of valves may be provided at a plurality of points, respectively, on the internal flow path 30 to be configured to perform a predetermined function.

Meanwhile, referring back to FIG. 1, the factor value sensor 60 may be installed in the internal flow path 30 and water storage tank 50 of the water purifier 1 according to an embodiment of the present invention. The factor value sensor 60 is configured to measure the value of a water ejection amount influencing factor that may affect the water ejection amount of the water purifier 1.

As the present water purifier 1 is a water storage type water purifier as described above, the water ejection amount influencing factor may include the amount of water stored in the water storage tank 50 and the temperature of the water ejected. In order to measure this, the factor value sensor 60 may include a temperature sensor 61 for measuring the temperature of water ejected through the water outlet member WO, a purified water quantity measurement sensor 63 for measuring the amount of purified water stored in the purified water tank 51, a hot water amount measurement sensor 64 for measuring the amount of hot water stored in the hot water tank 52, and a cold water amount measurement sensor 65 for measuring the amount of cold water stored in the cold water tank 54.

Hereinafter, the amount of purified water stored in the purified water tank 51, the amount of hot water stored in the hot water tank 52, and the amount of cold water stored in the cold water tank 54 are collectively referred to as the amount of water stored in the water storage tank 50.

Meanwhile, the temperature sensor 61 may be composed of a sensor that measures temperature based on the change in volume or resistance of a material that changes depending on temperature, but as long as the temperature of the water being ejected can be measured, the type or installation location of the temperature sensor 61 is not particularly limited.

And, the purified water quantity measurement sensor or the cold water amount measurement sensor 63 to 65 may be composed of a water level sensor that measures the amount of stored water by measuring the water level of the tank, a weight sensor that measures the amount of stored water by measuring the weight of the tank, etc., but as long as the amount of water stored in the tank can be measured, their type or installation location is not particularly limited.

Furthermore, according to an embodiment of the present invention, the factor value sensor 60 may include a flow rate sensor 62 for measuring the flow rate of purified water ejected through the water outlet member WO. In the present embodiment, the flow rate sensor 62 is configured to measure the flow rate of fluid flowing through the eighth flow path WL8. However, the type or location of the flow rate sensor 62 is not particularly limited as long as it can measure the water ejection amount ejected through the water outlet member WO.

Next, referring back to FIG. 1, in the present embodiment, the input panel 70 may be provided on one side of the housing 10, and the processor 80 may be provided inside the housing 10. The input panel 70 may be configured to receive input of certain information from the user.

In this case, in addition to the above-described functions, the input panel 70 may be configured to inform the user of the current status of the water purifier 1. And, in the present embodiment, the processor 80 may be electrically connected to the control valve 40, the factor value sensor 60, and the input panel 70, and may be configured to control whether water is ejected from the water purifier 1 and the water ejection amount.

First, referring to FIGS. 1 and 2, in the present embodiment, the input panel 70 may include a panel unit 71, an operation unit 72, a light source unit 73, and a mark unit 74. As an example, the panel unit 71 may be composed of a PCB on which electrical elements or devices constituting the operation unit 72, the light source unit 73, and the mark unit 74 can be mounted, but is not limited thereto.

In the present embodiment, the operation unit 72 may be composed of a plurality of button members provided on the panel unit 71 so that they can be pressed and operated. More specifically, the operation unit 72 may include first to fifth button members B1 to B5 that can be pressed and operated. In this case, at least a portion of the operation unit 72 may be directly or indirectly exposed to the outside of the housing 10 so that it can be operated by a user.

In this case, each button member may be composed of a mechanical button that can be physically pressed and operated, a touch button that can be pressed and operated by contact, etc. However, the type or input method of the button member is not particularly limited as long as it is configured to allow the user to input predetermined information by pressing the button member.

In the present embodiment, the first button member B1 may be configured to receive information that allows the water purifier 1 to start or stop ejecting water. That is, when the first button member B1 is pressed in a predetermined manner, the panel unit 71 may be configured to convert the pressing operation into general water ejection start information or general water ejection stop information and transmit it to the processor 80.

In this case, the general water ejection start information may mean signal information for controlling the control valve 40 so that the water stored in the water storage tank 50 starts to eject, and the general water ejection stop information may mean signal information for controlling the control valve 40 to stop the water ejection.

As an example, when the first button member B1 is pressed once, the panel unit 71 may transmit general water ejection start information to the processor 80, and when the first button member B1 is pressed once and then additionally pressed once, the panel unit 71 may transmit general water ejection stop information to the processor 80.

As another example, when the first button member B1 is pressed once, the panel unit 71 may transmit general water ejection start information to the processor 80, and when the pressing operation of the first button member B1 is released (for example, when the user removes the finger pressing the first button member B1 from the first button member B1), the panel unit 71 may transmit general water ejection stop information to the processor 80.

Next, according to an embodiment of the present invention, the second button member B2 may be configured to receive information that allows the water purifier 1 to be switched to a state in which hot water can be ejected.

As an example, when the second button member B2 is pressed once, the panel unit 71 may transmit a control signal for controlling the control valve 40 to the processor 80 to connect the flow path in a state in which the hot water stored in the hot water tank 52 can be ejected through the water outlet member WO. Afterwards, when general water ejection start information is input through the first button member B1, hot water will be ejected through the water outlet member WO.

Meanwhile, when the second button member B2 is pressed once and then additionally pressed once, the panel unit 71 may transmit a control signal for controlling the control valve 40 to the processor 80 to connect the flow path in a state in which the purified water stored in the purified water tank 51 can be ejected through the water outlet member WO.

Of course, the panel unit 71 may transmit the control signal directly to the control valve 40.

Next, according to an embodiment of the present invention, the third button member B3 may be configured to receive information that allows the water purifier 1 to be switched to a state in which cold water can be ejected.

As an example, when the third button member B3 is pressed once, the panel unit 71 may transmit a control signal for controlling the control valve 40 to the processor 80 to connect the flow path in a state in which the cold water stored in the cold water tank 54 can be ejected through the water outlet member WO. Afterwards, when general water ejection start information is input through the first button member B1, cold water will be ejected through the water outlet member WO.

Meanwhile, when the third button member B3 is pressed once and then additionally pressed once, the panel unit 71 may transmit a control signal for controlling the control valve 40 to the processor 80 to connect the flow path in a state in which the purified water stored in the purified water tank 51 is ejected through the water outlet member WO.

Of course, the panel unit 71 may transmit the control signal directly to the control valve 40.

In this case, information input through the above-described second and third button members B2 and B3 may include information on water ejection amount influencing factors. Hereinafter, the above information is referred to as information about the set temperature.

This is because the information about the set temperature is used to set the temperature of the water ejected, and may affect the water ejection amount ejected through the water purifier 1. As such, according to the present embodiment, the input panel 70 may be configured to receive information on water ejection amount influencing factors.

Next, according to an embodiment of the present invention, the fourth button member B4 may be configured to receive input of water ejection amount selection information. In this case, in the present embodiment, the water ejection amount that can be selected by the user may include at least one preset water ejection amount and a user water ejection amount described later.

Here, the user water ejection amount may mean the water ejection amount directly set through the input panel 70 by the user in the hope that the user will receive of receiving ejection. A method for a user to set a user water ejection amount will be described later in connection with a method for controlling a water purifier according to an embodiment of the present invention.

In the present embodiment, the preset water ejection amount may include first to third preset water ejection amounts. In this case, the first preset water ejection amount may be 120 ml, the second preset water ejection amount may be 250 ml, and the third preset water ejection amount may be 500 ml. However, the number or value of the preset water ejection amount is not particularly limited.

In the present embodiment, when the fourth button member B4 is pressed once or twice or more in succession, the panel unit 71 may be configured to transmit water ejection amount selection information to the processor 80. For example, when the fourth button member B4 is pressed twice in succession, the panel unit 71 may transmit water ejection amount selection information indicating that the second preset water ejection amount has been selected to the processor 80, and when the fourth button member B4 is pressed four times in succession, the panel unit 71 may transmit water ejection amount selection information indicating that the user water ejection amount has been selected to the processor 80.

Next, according to an embodiment of the present invention, the fifth button member B5 may be configured to receive first user input information. In this case, the first user input information may include information for switching the water purifier 1 to a state in which the user can set the user water ejection amount (hereinafter referred to as a configurable state) and information that switches the water purifier 1 to its previous state (hereinafter referred to as a normal state).

As an example, when the fifth button member B5 is pressed once, the panel unit 71 may transmit information for switching the water purifier 1 to the configurable state to the processor 80.

Meanwhile, when the fifth button member B5 is pressed once and then additionally pressed once, the panel unit 71 can transmit information for switching the water purifier 1 to the normal state to the processor 80. Of course, if second user input information, which will be described later, is input after the first user input information is input, it may be configured to automatically switch from the configurable state to the normal state.

Again, referring to FIGS. 1 and 2, the panel unit 71 may be provided with a light source unit 73. In the present embodiment, the light source unit 73 may include at least one light source for displaying information about the currently selected water ejection amount to the user. In this case, the light source may be made of a certain light-emitting element, such as an LED element.

According to the present embodiment, the number of light source units 73 may correspond to the number of water ejection amounts that can be selected by the user. More specifically, in the present embodiment, the light source unit 73 may include first to fourth light sources L1 to L4.

In this case, in the present embodiment, any one of the first to fourth light sources L1 to L4 may be configured to emit light to display the currently selected water ejection amount. For example, if the currently selected water ejection amount is the third preset water ejection amount (i.e., 500 ml), it may be configured that the third light source L3 turns on, and the remaining light sources turn off.

Also, in the present embodiment, a mark unit 74 that the user can check may be provided on the outer surface of the panel unit 71. In the present embodiment, the mark unit 74 may be configured to display information about the operation unit 72 and the light source unit 73. To this end, the mark unit 74 may include first to ninth marks M1 to M9.

In the present embodiment, the first mark M1 may be configured to display information about the first button member B1 and may be disposed on the side of the first button member B1. More specifically, the first mark M1 may include text information such as ejection to indicate that water ejection can be started or stopped when the first button member B1 is operated.

And, the second and third marks M2 may be configured to display information about the second and third button members B2 and B3, and may be disposed on the sides of the second and third button members B2 and B3, respectively. More specifically, the second mark M2 may include text information such as hot to indicate that the state can be switched to a state in which hot water can be ejected when the second button member B2 is operated, and the third mark M3 may include text information such as cold to indicate that the state can be switched to a state in which cold water can be ejected when the third button member B3 is operated.

And, the fourth mark M4 may be configured to display information about the fourth button member B4 and may be disposed on the side of the fourth button member B4. More specifically, the fourth mark M4 may include text information such as amount of water to indicate that the water ejection amount can be selected when the fourth button member B4 is operated.

And, the fifth mark M5 may be configured to display information about the fifth button member B5 and may be disposed on the side of the fifth button member B5. More specifically, the fifth mark M5 may include text information such as USER on/off to indicate that it can be switched to the configurable state or the normal state when the fifth button member B5 is operated.

And, the sixth to ninth marks M6 to M9 may be configured to display information about the first to fourth light sources L1 to L4 and may be disposed on the sides of the first to fourth light sources L1 to L4, respectively. More specifically, the sixth to eighth marks M6 to M8 may include text information such as 120 ml, 250 ml, 500 ml, etc., respectively to indicate that the state in which any one of the first to third light sources L1 to L3 emits light is a state in which the first to third preset water ejection amount can be ejected, and the ninth mark M9 may include information such as USER (user water ejection amount), etc. to indicate that the state in which the fourth light source L4 emits light is a state in which the user water ejection amount can be ejected.

Meanwhile, in the present embodiment, the mark unit 74 is provided on the outer surface of the panel unit 71, but if necessary, the mark unit 74 may be provided corresponding to a portion of the outer surface of the housing 10 where the input panel 70 is installed.

Hereinafter, a modified example of an input panel according to an embodiment of the present invention will be briefly described with different drawings.

Referring to FIG. 3, the input panel 170 according to a modified example of the above-described embodiment may include a panel unit 71, an operation unit 72, a display unit 173, and a mark unit 74. In this case, the same reference numerals shown in FIGS. 2 and 3 and the components they refer to may be understood as indicating the same components.

In the present modified example, the display unit 173 may replace the function of the light source unit 73 (shown in FIG. 2) of the above-described embodiment. The display unit 173 may be made of a predetermined display panel mounted on the panel unit 71. Of course, the light source unit 73 (shown in FIG. 2) of the above-described embodiment and the display unit 173 may be provided together.

According to the present modified example, the display unit 173 may be configured to display the current state of the water purifier 1. For example, the display unit 173 may be configured to display information regarding the water ejection amount selected by the user, information indicating whether the current state of the water purifier 1 is the configurable state or the normal state, etc., in text.

Referring back to FIG. 1, the water purifier 1 according to an embodiment of the present invention may be equipped with a processor 80. In the present embodiment, the processor 80 may be configured to control the amount or temperature of water ejected through the water outlet member WO. To this end, the processor 80 may be electrically connected to the control valve 40 and the input panel 70.

This processor 80 may be implemented using an electrical circuit processed by hardware, or implemented by a processor, central processing unit (CPU), controller, arithmetic logic unit, computational logic circuit, digital signal processing unit, microcomputer, FPGA, system on chip (SoC), programmable logic unit, microprocessor or any device capable of performing the functions described below.

A method for controlling the amount or temperature of water ejected by the processor 80 of the water purifier 1 according to an embodiment of the present invention will be described later in relation to a method for controlling a water purifier according to an embodiment of the present invention.

Meanwhile, in the present embodiment, although the processor 80 is shown separated from the panel unit 71 of the input panel 70 described above, the processor 80 may be configured to be mounted on one surface of the panel unit 71.

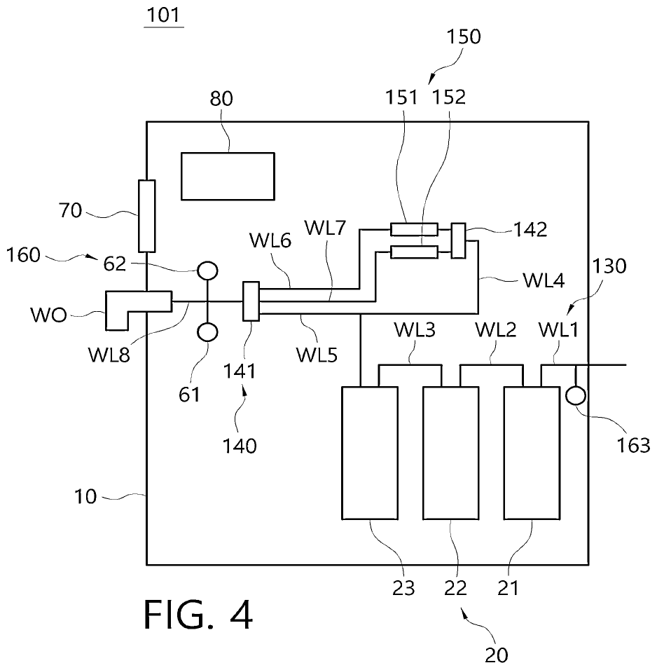

Hereinafter, a water purifier according to another embodiment of the present invention will be described with different drawings. FIG. 4 is a diagram schematically illustrating a water purifier according to another exemplary embodiment of the present invention.

Referring to FIG. 4, the water purifier 101 according to the present embodiment may be configured as a direct water purifier, including a housing 10, a filter 20, an internal flow path 130, a control valve 140, a temperature control unit 150, a factor value sensor 160, an input panel 70, and a processor 80.

In this case, in the present embodiment, the internal flow path 130 may include first to eighth flow paths WL1 to WL8 and a water outlet member WO, the control valve 140 may include a first control valve 141 and a second control valve 142, and the factor value sensor 160 may include a temperature sensor 61, a flow rate sensor 62 and a pressure sensor 163.

In this case, the housing 10; the filter 20; the first to third flow paths WL1 to WL3, the eighth flow path WL8, and the water outlet member WO of the internal flow path 130; the temperature sensor 61 and the flow rate sensor 62 of the factor value sensor 160; the input panel 70; and the processor 80 according to the present embodiment may be configured identically to the corresponding components of the water purifier according to the embodiment described with FIG. 1, and thus description thereof will be replaced with the description of the above-described embodiment.

In the present embodiment, the fourth flow path WL4 of the internal flow path 130 may be configured to fluidly connect the third filter 23 and the second control valve 142. Accordingly, purified water generated in the third filter 23 may be introduced into the second control valve 142.

And, in the present embodiment, the fifth flow path WL5 may be configured to branch from the fourth flow path WL4 and be fluidly connected to the first control valve 141. Accordingly, purified water flowing through the fourth flow path WL4 may be introduced into the first control valve 141.

And, in the present embodiment, a sixth flow path WL6 and a seventh flow path WL7 configured to fluidly connect the second control valve 142 and the first control valve 141 may be provided between the second control valve 142 and the first control valve 141.

Here, the second control valve 142 may be configured to connect the fourth flow path WL4, the sixth flow path WL6, and the seventh flow path WL7 in a predetermined manner. For example, the second control valve 142 may fluidly connect the fourth flow path WL4 and the sixth flow path WL6, or fluidly connect the fourth flow path WL4 and the seventh flow path WL7.

And, in the present embodiment, a hot water unit 151 may be installed in the sixth flow path WL6, and a cold water unit 152 may be installed in the seventh flow path WL7. The hot water unit 151 may include a heater, etc. capable of heating water flowing through the sixth flow path WL6 to a predetermined temperature, and the cold water unit 152 may include an evaporation tube, etc. that can cool the water flowing through the seventh flow path WL7 to a predetermined temperature.

In the present embodiment, the first control valve 141 may be configured to be fluidly connected to the eighth flow path WL8 fluidly connected to the water outlet member WO. In this case, the first control valve 141 may be configured to connect the fifth to eighth flow paths WL5 to WL8 in a predetermined manner.

For example, the first control valve 141 may connect the sixth flow path WL6 and the eighth flow path WL8. Accordingly, hot water flowing through the sixth flow path WL6 may be ejected through the water outlet member WO.

Meanwhile, referring to FIG. 1, a pressure sensor 163 may be provided in the first flow path WL1. The pressure sensor 163 may be configured to measure the pressure of raw water flowing through the first flow path WL1. However, the type or installation location of the pressure sensor 163 is not particularly limited as long as it can measure the pressure of the raw water described above. In the present embodiment, the pressure sensor 163 may measure the pressure of raw water as a water ejection amount influencing factor of the water purifier 1.

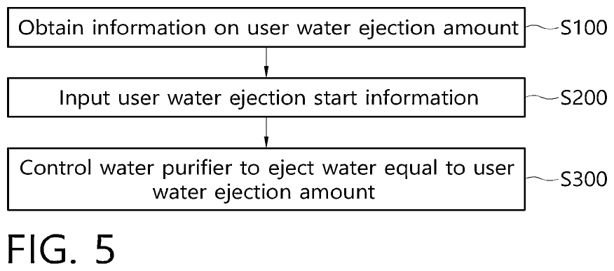

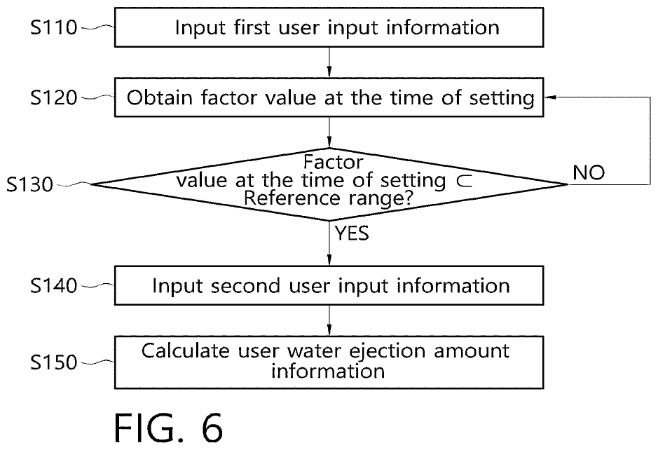

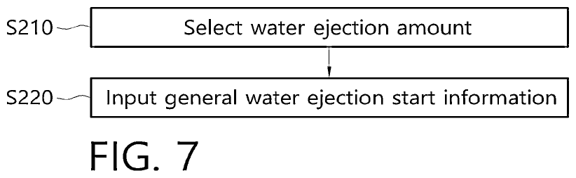

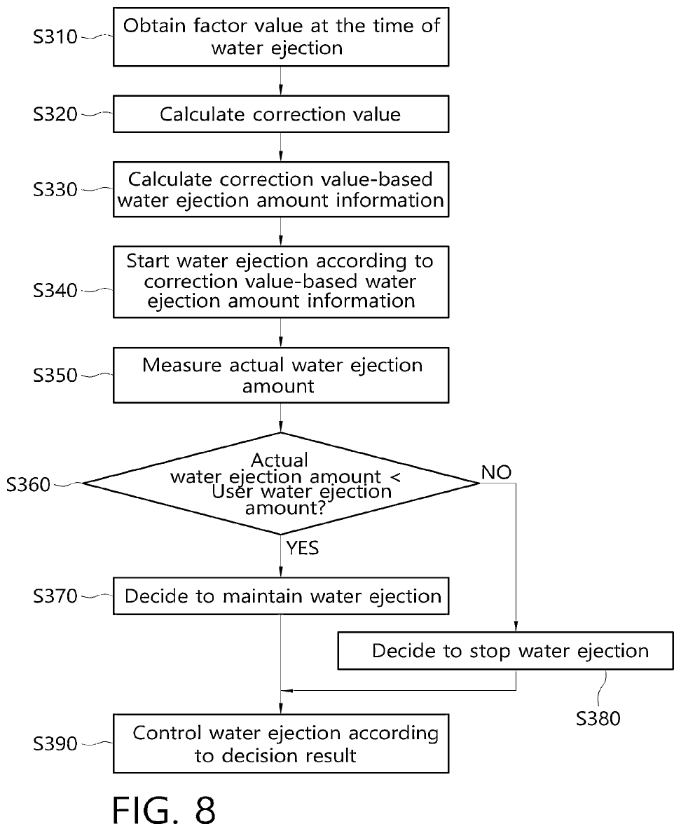

Hereinafter, a method for controlling a water purifier according to an embodiment of the present invention will be described with different drawings. FIG. 5 is a flowchart of a method for controlling a water purifier according to an exemplary embodiment of the present invention. FIG. 6 is a flowchart detailing step S100 of FIG. 5. FIG. 7 is a flowchart detailing step S200 of FIG. 5. FIG. 8 is a flowchart detailing step S300 of FIG. 5.

The method for controlling a water purifier according to an embodiment of the present invention is a method for accurately ejecting water in an amount corresponding to the user water ejection amount the user wishes to eject. The method for controlling a water purifier according to the present embodiment may be configured to control the water purifier 1 shown in FIG. 1 or the water purifier 101 shown in FIG. 4, but the water purifiers that can be controlled by the method for controlling a water purifier according to the present embodiment are not limited to those described above.

Referring to FIGS. 1, 2, 5, and 6, in the method for controlling a water purifier according to an embodiment of the present invention, the processor 80 obtains information on a user water ejection amount in step S100. In this case, in step S100 according to the present embodiment, first user input information is first received from the user through the input panel 70 in step S110.

In this case, the first user input information is information for switching the water purifier 1 from the normal state to the configurable state, as described above, and can be obtained by the user pressing the fifth button member B5 of the input panel 70.

More specifically, in the present embodiment, the first user input information can be obtained by the user pressing the fifth button member B5 over a predetermined time interval. For example, the time interval may be 3 seconds. Through this, the user's intention to set the user water ejection amount can be input more accurately.

Meanwhile, in step S110 according to the present embodiment, when the first user input information is input and the state of the water purifier 1 is switched to the configurable state, predetermined information can be output to the outside to indicate to the user that the first user input information has been input. For example, a separate speaker (not shown) provided in the water purifier 1 may be configured to output a voice message such as ‘User water ejection amount can be set’.

Next, in step S110 according to the present embodiment, when the first user input information is input in step S110, the factor value sensor 60 or the input panel 70 obtains information about a factor value at the time of setting a water ejection amount influencing factor in step S120. Here, the factor value at the time of setting refers to a measurement value of the water ejection amount influencing factor obtained within a predetermined time range based on the time when the first user input information is input.

For example, the factor value at the time of setting may be a measurement value of the water ejection amount influencing factor obtained between 3 seconds before and 3 seconds after the first user input information is input, but the time range can be set as needed. Through this step, the status of the water ejection amount influencing factor at the time of setting the user water ejection amount can be confirmed.

In this case, the water ejection amount influencing factor may be the temperature of the water ejected through the water outlet member WO. Alternatively, the water ejection amount influencing factor may be information about the set temperature input by the user through the input panel 70. Alternatively, as shown in FIG. 1, if the water purifier 1 is a water storage type water purifier, the water ejection amount influencing factor may be the amount of water stored in the water storage tank 50. Alternatively, as shown in FIG. 4, if the water purifier 101 is a direct water purifier, the water ejection amount influencing factor may be the pressure of raw water.

Meanwhile, there may be multiple water ejection amount influencing factors. For example, as in the present embodiment, the water ejection amount influencing factors may include the temperature of the water being ejected as a first water ejection amount influencing factor, information about the set temperature as a second water ejection amount influencing factor, and the amount of water stored in the water storage tank 50 as a third water ejection amount influencing factor.

And, in step S100 according to the present embodiment, the processor 80 compares the factor value at the time of setting obtained in step S120 with a reference range in step S130. Here, the reference range refers to a range set to reduce errors that may occur in the second user input information, which will be described later, due to the water ejection amount influencing factor. This reference range can be appropriately set depending on the configuration of the water purifier 1, the installation location, the characteristics of water ejection amount influencing factors, etc.

As an example, as shown in FIG. 1, if the water purifier 1 is a water storage type water purifier and the water ejection amount influencing factor includes the amount of water stored in the water storage tank 50, the reference range may be set to 20% to 80% of the total capacity of the water storage tank 50. This is because, if the amount of water stored in the water storage tank 50 is too small or excessive, the water pressure in the water storage tank 50 is too low or high, so the amount of water ejected per unit time may fluctuate relatively significantly.

As another example, as shown in FIG. 4, if the water purifier 101 is a direct water purifier and the water ejection amount influencing factor includes the pressure of raw water flowing through the first flow path WL1, the reference range can be set to 80% to 120% of the raw water pressure in the normal state. This is because if the pressure of raw water is too low or too high, the amount of water ejected per unit time may fluctuate relatively significantly.

Meanwhile, in the present embodiment, if there are a plurality of water ejection amount influencing factors, the processor 80 may perform step S130 only for some of the plurality of water ejection amount influencing factors. For example, if the water ejection amount influencing factors include the temperature of the water being ejected, the set temperature input by the user, and the amount of water stored in the water storage tank 50, it may be configured to perform step S130 only for the amount of water stored in the water storage tank 50. Of course, it may be configured to perform step S130 for all water ejection amount influencing factors.

According to the present embodiment, in step S130, if it is determined that the factor value at the time of setting does not fall within the reference range, it may be configured to perform step S120 again without performing step S140, which will be described later.

In this case, in the present embodiment, the processor 80 may output predetermined information to the outside to inform the user that step S120 must be performed again. For example, the processor 80 may output a voice message such as ‘Please press the USER on/off button again in a moment’ through a speaker separately provided in the water purifier 1.

As such, according to the water purifier and the method for controlling a water purifier according to an embodiment of the present invention, by minimizing errors in the second user input information caused by the water ejection amount influencing factors through step S130, more accurate second user input information can be obtained, and using this, the amount of water corresponding to the user water ejection amount can be accurately ejected.

Referring back to FIGS. 1, 2, 3, and 6, in step S100 according to an embodiment of the present invention, if the comparison result in step S130 determines that the factor value at the time of setting is within the reference range, second user input information is input through the input panel 70 in step S140. Here, the second user input information refers to information about the user water ejection amount the user wishes to receive.

According to the present embodiment, the second user input information may include general water ejection start information input by the user by pressing the first button member B1 of the input panel 70 once, and general water ejection stop information input by the user pressing the first button member B1 once and then twice.

However, the content and input method of the second user input information may be modified in various ways as needed. For example, the second user input information may include information input by the user pressing the first button member B1 of the input panel 70 and then maintaining the pressed state.

Next, in step S100 according to an embodiment of the present invention, the processor 80 calculates user water ejection amount information using the second user input information input in step S140 in step S150. Here, the user water ejection amount information refers to information converted into a form that the processor 80 can use to control the control valve 40.

In the present embodiment, the processor 80 may calculate information about the time interval between the time when the user inputs the general water ejection start information and the time when the user inputs the general water ejection stop information in step S140. That is, the processor 80 may calculate the amount of time for which water was ejected in step S140.

Accordingly, the user water ejection amount information may include information about the time interval. Meanwhile, the method by which the processor 80 calculates the user water ejection amount information may be appropriately modified according to the second user input information.

Referring back to FIGS. 1, 2, and 5, in the method for controlling a water purifier according to an embodiment of the present invention, information on the user water ejection amount is obtained through the above-described steps in step S100, and user water ejection start information is input through the input panel 70 in step S200. Here, the user water ejection start information refers to information entered by the user to receive water equal to the user water ejection amount.

Referring to FIG. 7 together, in step S200 according to the present embodiment, first, water ejection amount selection information for selecting the water ejection amount is input through the input panel 70 in step S210. The water ejection amount selection information is information for selecting one of the first to third preset water ejection amounts and the user water ejection amount.

In this case, according to the present embodiment, in step S210, the water ejection amount selection information may be input by successively pressing the fourth button member B4 of the input panel 70 once or twice or more.

For example, when the user presses the fourth button member B4 four times in succession, the first to fourth light sources L1 to L4 of the light source unit 73 may be sequentially turned on and off, and then finally, the fourth light source L4 may remain turned on. Accordingly, the user may confirm that the user water ejection amount has been selected.

And, in step S200 according to the present embodiment, water ejection amount selection information is input in step S210, and general water ejection start information is input in step S220. For example, the general water ejection start information may be input by the user pressing the first button member B1 of the input panel 70 once.

As such, in step S200 according to the present embodiment, step S210, in which water ejection amount selection information for selecting the user water ejection amount is input, and step S220, in which general water ejection start information is input, are performed sequentially, so that the user water ejection start information can be input.

Meanwhile, in the method for controlling a water purifier according to an embodiment of the present invention, in order to increase user convenience, a default value can be set to the user water ejection amount. In this case, the default value may mean the amount of water ejected when the above-mentioned general water ejection start information is input.

Hereinafter, the state in which the default value of the water purifier 1 is set to the user water ejection amount is referred to as a default setting state, and the state in which the default value is not set is referred to as a default non-setting state.

To this end, in step S210 according to the present embodiment, default setting information may be input as water ejection amount selection information through the input panel 70. Here, the default setting information is information entered to set the user start information to general water ejection start information.

For example, default setting information may be input by the user pressing the fourth button member B4 of the input panel 70 and then maintaining the pressing operation for a predetermined period of time. As an example, the predetermined period of time may be 3 seconds, but is not limited thereto.

As such, after the default setting information is input, if only step S220 in which general water ejection start information is input is performed, step S200 for inputting user water ejection start information can be completed at once, thereby increasing user convenience.

Meanwhile, the step for switching the water purifier 1 from the default setting state to the default non-setting state may be performed by performing the same steps as the step of setting the above-described default value as the user water ejection amount.

Referring back to FIGS. 1, 2, and 6, in the method for controlling a water purifier according to an embodiment of the present invention, user water ejection start information is input in step S200, and the processor 80 controls the control valve 40 to eject water equal to the user water ejection amount in step S300.

Referring to FIG. 8 together, in step S300 according to an embodiment of the present invention, first, the input panel 70 or the factor value sensor 60 obtains a factor value at the time of water ejection in step S310. Here, the factor value at the time of water ejection refers to a measurement value of the water ejection amount influencing factor obtained within a predetermined time range based on the time when the user water ejection start information is input.

For example, the factor value at the time of water ejection may be a measurement value of the water ejection amount influencing factor obtained between 3 seconds before and 3 seconds after the user water ejection start information is input, but the time range can be set as needed. Through this step, the status of the water ejection amount influencing factor at the time of ejecting water can be confirmed.

And, in step S300 according to the present embodiment, a factor value at the time of water ejection is obtained in step S310, and the processor 80 calculates a correction value K using the factor value at the time of setting obtained in step S120, the factor value at the time of water ejection obtained in step S310, and the user water ejection amount information calculated in step S150 (S320).

In this case, the correction value K refers to a value for correcting an error in the water ejection amount that may occur due to the difference between the water ejection amount influencing factor in step S100 and the water ejection amount influencing factor in step S300. In other words, the correction value K is intended to correct an error in the water ejection amount that may occur due to the difference between the factor value at the time of water ejection and the factor value at the time of setting. This correction value K can be set appropriately according to the characteristics of the water ejection amount influencing factors.

As an example, if the water ejection amount influencing factor is the temperature of the water being ejected, the correction value K may be calculated as a predetermined integer that is proportional or inversely proportional to the difference between the temperature of the water ejected at the time of performing step S100 (that is, factor value at the time of setting) and the temperature of the water ejected at the time of performing step S300 (that is, factor value at the time of water ejection). In this case, if the factor value at the time of setting is greater than the factor value at the time of water ejection, the correction value K may be calculated as an integer between 0 and 1; if the factor value at the time of setting and the factor value at the time of water ejection are the same, the correction value K may be calculated as 1; and if the factor value at the time of setting is smaller than the factor value at the time of water ejection, the correction value K may be calculated as an integer greater than 1, but it is not limited thereto.

As another example, if the water ejection amount influencing factor is information about the set temperature input by the user, the correction value K may be determined as a predetermined integer. Specifically, if the information about the set temperature input by the user in step S100 (i.e., factor value at the time of setting) and the information about the set temperature input by the user in step S300 (i.e., factor value at the time of water ejection) are the same, the correction value K may be determined as 1; if the factor value at the time of setting is an input for ejecting water from the purified water tank 51 (hereinafter referred to as general temperature setting input) and the factor value at the time of water ejection is an input for ejecting water from the hot water tank 52 (hereinafter referred to as hot water setting input), the correction value K may be determined as Ka; if the factor value at the time of setting is the general temperature setting input and the factor value at the time of water ejection is a value for ejecting water from the cold water tank 54 (hereinafter referred to as cold water setting input), the correction value K may be determined as Kb; if the factor value at the time of setting is the cold water setting input and the factor value at the time of water ejection is the general temperature setting input, the correction value K may be determined as 1/Kb; if the factor value at the time of setting is the cold water setting input and the factor value at the time of water ejection is the hot water setting input, the correction value K may be determined as 1/(Kb*Ka); if the factor value at the time of setting is the hot water setting input and the factor value at the time of water ejection is the general temperature setting input, the correction value K may be determined as 1/Ka; and if the factor value at the time of setting is the hot water setting input and the factor value at the time of water ejection is the cold water setting input, the correction value K may be determined as 1/(Ka*Kb); but it is not limited thereto. Here, Ka and Kb may be constants with predetermined values. For example, Ka may be 1.16, and Kb may be 0.82, but it is not limited thereto, and Ka and Kb may be determined by repeatedly performing a predetermined water ejection experiment on a water purifier in which the present method for controlling is implemented.

As yet another example, in a water storage type water purifier, if the water ejection amount influencing factor is the amount of water stored in the water storage tank 50, the correction value K may be calculated as a predetermined integer that is proportional or inversely proportional to the difference between the amount of water stored in the storage tank 50 at the time of performing step S100 (i.e., factor value at the time of setting) and the amount of water stored in the storage tank 50 at the time of performing step S300 (i.e., factor value at the time of water ejection). In this case, if the factor value at the time of setting is greater than the factor value at the time of water ejection, the correction value K may be calculated as an integer greater than 1; if the factor value at the time of setting and the factor value at the time of water ejection are the same, the correction value K may be calculated as 1; and if the factor value at the time of setting is smaller than the factor value at the time of water ejection, the correction value K may be calculated as an integer between 0 and 1, but it is not limited thereto.

As yet another example, in a direct water purifier, if the water ejection amount influencing factor is the pressure of raw water, the correction value K may be calculated as a predetermined integer that is proportional or inversely proportional to the difference between the raw water pressure at the time of performing step S100 (i.e., factor value at the time of setting) and the raw water pressure at the time of performing step S300 (i.e., factor value at the time of water ejection). In this case, if the factor value at the time of setting is greater than the factor value at the time of water ejection, the correction value K may be calculated as an integer greater than 1; if the factor value at the time of setting and the factor value at the time of water ejection are the same, the correction value K may be calculated as 1; and if the factor value at the time of setting is smaller than the factor value at the time of water ejection, the correction value K may be calculated as an integer between 0 and 1, but it is not limited thereto.

As such, the method for controlling a water purifier according to the present embodiment may calculate a correction value K that can correct an error in the water ejection amount due to the water ejection amount influencing factor through step S320.

Meanwhile, in step S320 according to the present embodiment, if there are a plurality of water ejection amount influencing factors, the processor 80 may calculate a correction value for each water ejection amount influencing factor, and calculate the final correction value K by processing the calculated correction values using a predetermined mathematical method.

For example, in step S320, if the water ejection amount influencing factor includes first to n^{th} water ejection amount influencing factors, the processor 80 may calculate the first to n^{th} correction values K1 to Kn by calculating a correction value for each water ejection amount influencing factor. And, the processor 80 may calculate the final correction value K using the first to n^{th} correction values K1 to Kn and the following [Equation 1].

$$K = K 1 * K 2 * … * Kn \qquad [ Equation 1 ]$$

Next, referring back to FIGS. 1, 5, and 8, in step S300 according to the present embodiment, the processor 80 calculates a correction value K in step S320, and the processor 80 calculates correction value-based water ejection amount information using the user water ejection amount information and the calculated correction value K in step S330.

In this case, in step S330 according to the present embodiment, the processor 80 may calculate correction value-based water ejection amount information based on [Equation 2] below. Here, the correction value-based water ejection amount information may include Tf defined by [Equation 2].

$$Tf = Ti * K \qquad [ Equation 2 ]$$

In this case, Ti in [Equation 2] is a value calculated in step S150 and may mean the time interval between the time when general water ejection start information is input and the time when general water ejection stop information is input in step S140. That is, Ti may mean the amount of time for which water was ejected in step S140.

Meanwhile, steps S320 and S330 according to the present embodiment were performed using simple [Equation 1] and [Equation 2], but the above-described [Equation 1] and [Equation 2] are merely exemplary, and steps S320 and S330 according to other embodiments of the present invention may be performed by various mathematical methods.

Referring back to FIGS. 1, 5, and 8, in step S300 according to an embodiment of the present invention, the processor 80 calculates correction value-based water ejection amount information in step S330, and the processor 80 controls the control valve 40 to eject water according to the correction value-based water ejection amount information calculated in step S330 in step S340.

In the present embodiment, the processor 80 may control the control valve 40 so that water is ejected from the water outlet member WO for a time corresponding to Tf of [Equation 2] included in the correction value-based water ejection amount information.

As such, according to the water purifier and the method for controlling a water purifier according to an embodiment of the present invention, since it is configured to reflect the measured value of the water ejection amount influencing factor in step S100 (i.e., factor value at the time of setting) and the measured value of the water ejection amount influencing factor in step S300 (i.e., factor value at the time of water ejection) in the water ejection amount, the amount of water corresponding to the user water ejection amount can be accurately ejected.

Meanwhile, referring back to FIGS. 1, 5, and 8, in step S300 according to an embodiment of the present invention, the processor 80 controls the control valve 40 in step S340, the flow rate sensor 62 measures the actual water ejection amount ejected through the water outlet member WO in step S350, and the processor 80 compares the actual water ejection amount and the user water ejection amount in step S360.

And, in step S300 according to the present embodiment, the processor 80 determines whether to stop water ejection or maintain water ejection based on the comparison result of step S360 (S370, S380). More specifically, in the present embodiment, the processor 80 determines to maintain water ejection if the actual water ejection amount is less than the user water ejection amount in step S370, and determines to stop water ejection if the actual water ejection amount is greater than the user water ejection amount in step S380.

In this case, according to the present embodiment, in steps S370 and S380, the processor 80 may determine whether to eject water regardless of whether the amount of water according to the correction value-based water ejection amount information in step S330 has been ejected. This takes into account the fact that the amount of water according to the correction value-based water ejection amount information may not exactly match the user water ejection amount.

Next, referring back to FIGS. 1, 5, and 8, in step S300 according to an embodiment of the present invention, the processor 80 determines whether to stop ejecting water or maintain ejecting water in steps S370 and S380, and controls whether to eject water from the water purifier 1 based on the decision result in step S390.

In this case, in the method for controlling a water purifier according to the present embodiment, the processor 80 may repeatedly perform steps S350 to S390 until it decides to stop water ejection in step S380.

As such, in the method for controlling a water purifier according to an embodiment of the present invention, by controlling whether the water purifier maintains or stops water ejecting using the actual water ejection amount and the user water ejection amount, it is possible to more accurately eject water in an amount corresponding to the user water ejection amount.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

### DESCRIPTION OF SYMBOLS

| | |
|---|---|
| 1, 101: water purifier | 10: housing |
| 20: filter | 30, 130: internal flow path |
| 40, 140: control valve | 50: water storage tank |
| 150: water temperature control unit | 60, 160: factor value sensor |
| 70, 170: input panel | 80: processor |

What is claimed is:

1. A water purifier, comprising:
a housing;
a filter provided inside the housing to filter raw water to produce purified water;
a water outlet member that ejects purified water generated in the filter to the outside of the housing;
a control valve configured to control water ejection amount ejected through the water outlet member;
a factor value measurement sensor configured to obtain information on water ejection amount influencing factors that may affect the water ejection amount;
an input panel provided on one side of the housing to receive input of at least one of first user input information to allow to be switched to a state where a user can set the water ejection amount, second user input information on a user water ejection amount which is a water ejection amount that the user wishes to set, and user water ejection start information to ensure that water is ejected as much as the user water ejection amount; and
a processor configured to control the water ejection amount using information on the water ejection amount influencing factors when the user water ejection start information is input,
wherein the processor:
obtains a factor value at the time of setting of the water ejection amount influencing factor when the user water ejection amount is input,
obtains a factor value at the time of water ejection of the water ejection amount influencing factor when the user water ejection amount is input, and
controls the control valve to eject water equal to the user water ejection amount using the factor value at the time of setting, the factor value at the time of water ejection, and the second user input information.

2. The water purifier of claim 1, wherein the processor:
compares the factor value at the time of setting with a reference range set to reduce errors that may occur in the second user input information due to the water ejection amount influencing factor, and
receives input of the second user input information if the factor value at the time of setting is within the reference range.

3. The water purifier of claim 1, wherein the processor:
calculates user water ejection amount information using the second user input information,
calculates a correction value to correct an error in the water ejection amount that may occur due to the difference between the factor value at the time of setting and the factor value at the time of water ejection, and
calculates correction value-based water ejection amount information using the user water ejection amount information and the correction value, and
controls the control valve to eject water amount equal to the amount of water according to the correction value-based water ejection amount information.

4. The water purifier of claim 3, further comprising:
a flow rate sensor for measuring actual water ejection amount ejected through the water outlet member up to a predetermined reference time point,
wherein the processor:
compares the actual water ejection amount and the user water ejection amount,
maintains water ejection if the user water ejection amount is greater than the actual water ejection amount, even if the water amount equal to the amount of water according to the correction value-based water ejection amount information has been ejected, and
stops water ejection if the user water ejection amount is less than or equal to the actual water ejection amount, even if the water amount equal to the amount of water according to the correction value-based water ejection amount information has not been ejected.

5. The water purifier of claim 1,
wherein the input panel is configured to receive general water ejection start information to start water ejection and general water ejection stop information to stop water ejection as the second user input information, and
wherein the processor calculates information on the amount of water ejection time from the time water ejection starts according to the general water ejection start information to the time when water ejection is stopped according to the general water ejection stop information.

6. The water purifier of claim 1,
wherein the input panel is configured to receive input of water ejection amount selection information for selecting the amount of water to be ejected from at least one preset water ejection amount and the user water ejection amount, and general water ejection start information so as to start water ejection as much as the amount of water selected by the water ejection amount selection information, and
wherein the processor determines that the user water ejection start information is input if the general water ejection start information is input after the water ejection amount selection information for selecting the user water ejection amount is input.

7. The water purifier of claim 6, wherein the input panel comprises a water ejection amount selection button unit configured to receive input of the water ejection amount selection information by being pressed successively at least once.

8. The water purifier of claim 6,
wherein the input panel is configured to receive input of default setting information, and
wherein the processor determines the general water ejection start information as the user water ejection start information if the default setting information is input.

9. The water purifier of claim 1, wherein the factor value measurement sensor comprises at least one of a temperature sensor for measuring the temperature of water ejected through the water outlet member, a water storage sensor configured to measure the amount of water stored in a water storage tank where purified water generated by the filter is stored, and a pressure sensor for measuring the pressure of raw water flowing into the filter.

10. The water purifier of claim 1, wherein the input panel is configured to receive input of temperature information about the temperature of the water ejected as the water ejection amount influencing factor.

11. A method for controlling a water purifier, comprising:
obtaining information on a user water ejection amount which is a water ejection amount that a user wishes to set;
receiving input of user water ejection start information to ensure that water is ejected as much as the user water ejection amount;
controlling the water purifier to eject water equal to the user water ejection amount when the user water ejection start information is input,
wherein the obtaining information on the user water ejection amount comprises:
receiving input of first user input information to allow the water purifier to be switched to a state where a user can set water ejection amount;
obtaining a factor value at the time of setting of a water ejection amount influencing factor that can affect the water ejection amount of the water purifier;
receiving input of second user input information on a user water ejection amount which is a water ejection amount that the user wishes to set; and
calculating user water ejection amount information using the second user input information,
wherein the controlling the water purifier comprises:
obtaining a factor value at the time of water ejection of the water ejection amount influencing factor; and
controlling the water ejection amount to eject water equal to the user water ejection amount using the factor value at the time of setting, the factor value at the time of water ejection, and the user water ejection amount.

12. The method for controlling a water purifier of claim 11,
wherein the obtaining information on the user water ejection amount comprises:
comparing the factor value at the time of setting with a reference range set to reduce errors that may occur in the second user input information due to the water ejection amount influencing factor, and
wherein the receiving input of second user input information comprises:
receiving input of the second user input information if the factor value at the time of setting is within the reference range.

13. The method for controlling a water purifier of claim 11,
wherein the controlling the water purifier comprises:
calculating a correction value to correct an error in the water ejection amount that may occur due to the difference between the factor value at the time of setting and the factor value at the time of water ejection;
calculating correction value-based water ejection amount information using the user water ejection amount information and the correction value; and
controlling the water ejection amount of the water purifier to eject water amount equal to the amount of water according to the correction value-based water ejection amount information.

14. The method for controlling a water purifier of claim 13,
wherein the controlling the water ejection amount of the water purifier comprises:
measuring actual water ejection amount ejected from the start of water ejection to a predetermined reference time point;
comparing the actual water ejection amount and the user water ejection amount;
determining whether to stop water ejection or maintain water ejection based on the comparison result; and
controlling whether to eject water from the water purifier based on the decision result.

15. The method for controlling a water purifier of claim 14,
wherein the determining whether to stop water ejection or maintain water ejection comprises:
determining to maintain water ejection if the user water ejection amount is greater than the actual water ejection amount, even if the water amount equal to the amount of water according to the correction value-based water ejection amount information has been ejected, and
determining to stop water ejection if the user water ejection amount is less than or equal to the actual water ejection amount, even if the water amount equal to the amount of water according to the correction value-based water ejection amount information has not been ejected.

16. The method for controlling a water purifier of claim 11,
wherein the receiving input of second user input information comprises:
receiving general water ejection start information to start water ejection and general water ejection stop information to stop water ejection, and
wherein the calculating user water ejection amount information comprises:
calculating information on the amount of water ejection time from the time water ejection starts according to the general water ejection start information to the time when water ejection is stopped according to the general water ejection stop information.

17. The method for controlling a water purifier of claim 11,
wherein the receiving input of user water ejection start information comprises:
receiving input of information for selecting the water ejection amount as the amount of water to be ejected from at least one preset water ejection amount and the user water ejection amount; and
receiving general water ejection start information so as to start water ejection as much as the amount of water selected.

18. The method for controlling a water purifier of claim 17,
wherein the receiving input of information for selecting as the amount of water to be ejected comprises setting the general water ejection start information as the user water ejection start information.

19. The method for controlling a water purifier of claim 17,
wherein the receiving input of information for selecting as the amount of water to be ejected comprises successively pressing a water ejection amount selection button once or twice or more to select the amount of water to be ejected.

20. The method for controlling a water purifier of claim 11,
wherein the water ejection amount influencing factor comprises:
at least one of temperature of water ejected from the water purifier, amount of water storage stored in a water storage tank provided in the water purifier, and pressure of raw water flowing into the water purifier, and
wherein the correction value comprises:
at least one of a temperature-based correction value, a water storage amount-based correction value, and a pressure-based correction value corresponding to at least one of the temperature of the water, the amount of water storage, and the pressure of raw water.
